(19) United States
(12) Patent Application Publication
(10) Pub. No.: US 2016/0149703 A1
(43) Pub. Date: May 26, 2016

(54) METHOD FOR EFFICIENT POSTCOMPUTATION-BASED GENERIC-POINT PARALLEL SCALAR MULTIPLICATION

(71) Applicant: Umm Al-Qura University, Makkah (SA)

(72) Inventors: Turki F. Al-Somani, Makkah (SA); Ayman G. Fayoumi, Jeddah (SA); Mohammed K. Ibrahim, Makkah (SA)

(73) Assignee: Umm Al-Qura University

(21) Appl. No.: 14/554,679

(22) Filed: Nov. 26, 2014

(51) Int. Cl. H04L 9/30; G06F 7/72

(52) U.S. Cl. CPC H04L 9/3066; G06F 7/725; H04L 2209/34

(57) ABSTRACT

A method for efficient postcomputation-based generic-point scalar multiplication includes the following steps:
providing a plurality of eight elliptic curve cryptoprocessors and using the cryptoprocessors to perform scalar multiplication of a group of points on an elliptic curve in which kP denotes the scalar multiplication and wherein k is an integer and P is a point on the elliptic curve; and,
computing scalar multiplication on the plurality of elliptic curve cryptoprocessors by a series of point doubling and point additions that depend on the bit sequence that regenerates the scalar multiplier k; and
wherein the multiplier k is partitioned into u partitions that are processed by the plurality of elliptic curve processors as

k=(k^{u-1}∥k^{(u-2)}∥ . . . k⁽⁰⁾)

(u−1)(u−2).

### FIELD OF THE INVENTION

This invention relates to a method for an efficient postcomputation-based generic-point parallel scalar multiplication and more particularly to a method wherein a multiplier k is partitioned into u partitions that can be processed in parallel by u processors.

### BACKGROUND FOR THE INVENTION

Elliptic curve crypto systems (ECCs) are considered to be an alternative to the RSA systems but with a much shorter word length. For example, an elliptic curve cryptic system with a key size of 128 to 256 bits has been shown to offer equal security to an RSA system with a key size of 1-2 Kbits. To Applicant's knowledge no significant breakthroughs have been made in determining the weaknesses of ECCs, which are based on a discrete logarithm problem over points on an elliptic curve.

Scalar multiplication is the basic operation for ECCs. The scalar multiplication operation denoted as kP, where k is an integer and P is a point on the elliptic curve. The scalar multiplication is computed by a series of point doubling and point addition operations of the point P that depends on the bit sequence that represents the scalar multiplier k.

However, for high performance end servers, the current sequential scalar multiplication methods are too slow to meet the demands of an increasing number of users. Pre-computations have been applied to speed up scalar multiplication, but require sequential steps that cannot be parallelized. However, during secure communication sessions that use public keys the elliptic curve point changes, as it depends on the public key of the communicating entity. In other words, it is session dependent.

A U.S. Pat. No. 7,483,534 of Ibrahim discloses an elliptic polynomial cryptography with multi y coordinates embedding. As disclosed, given a set of elliptic points that satisfy an elliptic polynomial equation defined over a finite field, F which requires N-bits to represent its elements, a new method of cryptographic encryption and decryption is presented which uses more than one quadratic variable that are termed y-coordinates to obtain an elliptic polynomial equation with multi y-coordinates instead of one y coordinate. The additional y coordinates are used to embed extra message data bits. A ny-fold increase in the number of embedded message data bits in a single elliptic point can be achieved with the improved method when using ny additional y-coordinates. The reason is that the number of points that satisfy an elliptic polynomial equation defined over F(p) and which can be used in the corresponding crypto system is increased by a factor of (#F)^{ny}, where the # denotes the size of a field. The use of the additional y-coordinates can be used to reduce computational complexity. Alternatively, this can be used to increase security by making the bit positions where data bits are known only to the sender and receiver. Also it can be used as a countermeasure by randomizing the bit positions where data bits are embedded.

An additional U.S. Patent Publication No. 2003/0026419 of Akishita discloses an elliptic curve encryption processing method, elliptic curve encryption processing apparatus, and program. As disclosed, an elliptic curve encryption processing method and an elliptic curve encryption processing apparatus enable high-speed elliptic curve encryption processing computations to be realized. In elliptic curve encryption processing computations, two scalar multiplications, kP and 1Q, are not performed separately, but the computation process of kP+1Q is performed simultaneously. In the computation of scalar multiplications, kP and 1Q are set on a Montgomery elliptic curve By²=x³+Ax²+x. On the basis of a combination of each bit value of k and 1 from the high-order bits of the binary representation data of the scalar quantities k and 1, a computation relation of the next four points based on the computed four points is selected, and based on the selected relation, a process of computing the next four points is repeatedly performed to eventually compute kP+1Q.

A further U.S. Patent Publication No. 2003/0123656 of Izu et al. discloses an elliptic curve cryptosystem apparatus, storage medium storing elliptic curve cryptosystem program, and elliptic curve cryptosystem arithmetic method. As disclosed, a scalar multiplication can be performed on an elliptic curve cryptosystem at a high speed. P is set as an initial value of Q[0], and 2×P is set as an initial value of Q[1]. An elliptic curve doubling ECDBL of Q[d[i]] is performed, and an arithmetic result is stored in Q[2]. An elliptic curve addition ECADD of Q[0] and Q[1] is performed, and an arithmetic result is stored in Q[1]. Q[2−d[i]] is stored on Q[0]. Q[l+d[i]] is stored in Q[1]. The elliptic curve addition ECADD and the elliptic curve doubling ECDBL are concurrently performed in the respective processors.

Still further, a U.S. Pat. No. 7,957,527 of Katagi et al. discloses a cryptographic processing apparatus wherein an apparatus and a method for performing a hyperelliptic curve cryptographic at a high speed in a highly secure manner are provided. A base point D is produced such that the base point D and one or more of precalculated data in addition to the base point used in a scalar multiplication operation based on a window algorithm are degenerate divisors with a weight smaller than genus g of a hyperelliptic curve. An addition operation included in the scalar multiplication operation based on the window algorithm is accomplished by performing an addition operation of adding a degenerate divisor and a non-degenerate divisor whereby a high-speed operation is achieved without causing degradation in security against key analysis attacks such as SPA.

Finally, a simultaneous scalar multiplication method is disclosed in a U.S. Pat. No. 8,045,705 of Antipa et al. As disclosed, in computing point multiples in elliptic curve schemes (e.g. kP and sQ) separately using, for example, Montgomery's method for the purpose of combining kP+sQ several operations are repeated in computing kP and sQ individually, that could be executed at the same time. A simultaneous scalar multiplication method is provided that reduces the overall number of doubling and addition operations thereby providing an efficient method for multiple scalar multiplication. The elements in the pairs for P and Q method are combined into a single pair, and the bits in k and s are evaluated at each step as bit pairs. When the bits in k and s are equal, only one doubling operation and one addition operation are needed to compute the current pair, and when the bits in k and s are not equal, only one doubling operation is needed and two addition operations.

### SUMMARY OF THE INVENTION

A method for efficient postcomputation-based generic-point parallel scalar multiplication comprises the following steps:

providing a plurality of elliptic curve cryptoprocessors;

using the plurality of elliptic curve cryptoprocessors to perform scalar multiplication of a group of points on an elliptic curve wherein kP denotes the scalar multiplication and wherein k is an integer and P is a point on the elliptic curve;

computing scalar multiplication on the plurality of elliptic curve cryptoprocessors by a series of point doubling and point additions that depend on the bit sequence that represents the scalar multiplier k; and

wherein the multiplier k is partitioned into u partitions that are processed by the plurality of elliptic curve processors as k=(k^{(u-1)}∥k^{(u-2)}∥ . . . k⁽⁰⁾).

### DESCRIPTION OF THE PREFERRED EMBODIMENTS OF THE INVENTION

In an article published in 2010 entitled “Performance Analysis of the Postcomputation-Based Generic-Point Parallel Scalar Multiplication Method” by the Applicant Turki F. Al-Somani, a description of the elliptic curve crypto preliminaries states elliptic curve cryptosystems (ECCs) [4] have attracted much research attention and have been included in many standards. ECCs are evolving as an attractive alternative to other public-key schemes such as RSA by offering a smaller key size and a higher strength per bit. Extensive research has been conducted on the underlying math, security strength and efficient implementations of ECCs. Of the various fields that can underlie elliptic curves, prime fields GF(p) and binary fields GF(2m) have proved to be best suited to cryptographic applications. An elliptic curve E over the finite field GF(p) defined by the parameters a, bεGF(p) with p>3 consists of the set of points P=(x, y), where x, yεGF(p), that satisfies the equation

y²=x³+ax+b (1)

where a, b GF(p) and 4a³+27b²≠0 mod p, together with the additive identity of the group point O known as the “point at infinity’ [4]. The number of points #E on an elliptic curve over a finite field GF(q) is defined by Hasse's theorem [4]. The discrete points on an elliptic curve form an abelian group, the group operation of which is known as “point addition’. Elliptic curve point addition is defined according to the “chord-tangent process’. Point addition over GF(p) can be described as follows. Let P and Q be two distinct points on E defined over GF(p) with Q≠P (Q is not the additive inverse of P). The addition of the points P and Q gives the point R (R=P+Q), where R is the additive inverse of S and S is a third point on E intercepted by the straight line through points P and Q. The additive inverse of point P=(x, y)εE over GF(p) is the point −P=(x, −y), which is the mirror of point P with respect to the x-axis on E. When P=Q and P≠−P, the addition of P and Q is the point R (R=2P), where R is the additive inverse of S and S is the third point on E intercepted by the straight line tangential to the curve at point P. This operation is referred to as point doubling. The finite field GF(2^{m}) has particular importance in cryptography, as it leads to very efficient hardware implementations. Elements of the field are represented in terms of a basis. Most implementations use either a polynomial basis or a normal basis [8]. Letting GF(2^{m}) be a finite field of characteristic two, a nonsupersingular elliptic curve E over GF(2^{m}) can be defined as the set of solutions (x, y) GF(2^{m})×GF(2^{m}) to the equation

y²+xy=x³+ax²+b (2)

where a and bεGF(2^{m}), b≠0, together with the point at infinity. It is well known that E forms a commutative finite group, with O as the group identity, under the addition operation known as the tangent and chord method. Explicit rational formulas for the addition rule involve several field arithmetic operations (addition, squaring, multiplication and inversion) in the underlying finite field. The group operations in affine coordinate systems involve finite field inversion, which is a very costly operation, particularly for prime fields. Projective coordinate systems can be used to eliminate the need to perform inversions. Several projective coordinate systems have been proposed in the literature, including the homogeneous, Jacobian, Chudnovsky-Jacobian, modified Jacobian, Lopez-Dahab, Edwards and mixed coordinate systems [9][10]. Several scalar multiplication methods have been proposed in the literature [4]. Computing kP can be achieved with a straightforward binary method—the so-called double-and-add method—based on the binary expression of the multiplier k. kP can be computed using a binary method as follows. Let k=(kₘ₋₁, . . . , k₀), where kₘ₋₁ is the most significant bit of k, be the binary representation of k. The multiplier k can be written as

$$k = k = kP = {\sum }_{0 \leq i < m} {k}_{i} {2}^{i} = {k}_{m - 1} {2}^{m - 1} + … + {k}_{1} 2 + {k}_{0} \qquad ( 3 )$$

Using the Horner expansion, k can be rewritten as

k=(^{. . .} ((kₘ₋₁2+kₘ₋₂)2+^{. . .} +k₁)2+k₀) (4)

Accordingly,

kP=2(^{. . . 2}(2kₘ₋₁P+kₘ₋₂P)+^{. . .} +k₁P)+k₀P (5)

The algorithm for the binary method is as follows.

Algorithm 1: Binary Method

(1) Input P, k.
(2) Q ← O.
(3) For i from m − 1 down to 0, perform
a. Q ← 2Q,
b. If kᵢ = 1, then Q ← Q + P.
(4) End for.
(5) Output Q.

The binary scalar multiplication method is the most straightforward scalar multiplication method. It inspects the bits of the scalar multiplier k. If the inspected bit kᵢ=0, then only point doubling is performed. If, however, the inspected bit kᵢ=1, then both point doubling and addition are performed. The binary method requires m point doublings and an average of m/2 point additions. Non-adjacent form (NAF) reduces the average number of point additions to m/3 [11]. With NAF, signed-digit representations are used such that the scalar multiplier's coefficient kᵢε{0, +1}. NAF has the property that no two consecutive coefficients are nonzero. It also has the property that every positive integer k has a unique NAF encoding, which is denoted as NAF(k).

### Proposed Method

In [6], the multiplier k is partitioned into IA partitions as

k=(k^{(u-1)}∥k^{(u-2)}∥ . . . k⁽⁰⁾) (1)

where k=(kₘ₋₁, . . . , k₀) is the binary representation of k and kₘ₋₁, is the most significant bit of k. Each partition is mapped to a specific cryptoprocessor as

(k^{(t)},Cryptoprocessor₍ₜ₎) (2)

Scalar multiplication product kP can then be computed as

$$kP = {\sum }_{0 \leq i \leq u} {s}_{i} , \qquad ( 3 )$$

where tᵢ is defined as

sᵢ=(2^{iv})[2( . . . 2(2kᵢᵥ₊ᵥ₋₁P+kᵢᵥ₊ᵥ₋₂P)+ . . . +kᵢᵥ₊₁P)+kᵢᵥ₊₀P] (4)

Eq. (4) implies that each partition requires iv, where

$$v = ⌈ \frac{m}{u} ⌉$$

point doublings to produce the correct partial product. In [6], the multiplier k has been partitioned into u partitions of different sizes to balance the number of point operations in terms of the total number of field multiplications, which was the main reason limiting the performance of the proposed method in [6]. A key observation is that the mapping of equation (2) can be rescheduled whenever a new request for computing kP for a particular P and k appears. Accordingly, there is no need to make the key partitions with different sizes. Each partition size will be equal to ┌m/u┐ bits. Accordingly, equation (2) can be rewritten as

$$\begin{matrix}( {k}^{( ω )} , {Cryptoprocessor}_{( j )} ) \\ where & ( 5 ) \\ j = \{ \begin{matrix}i & for request number ( x ) \\ ( \begin{matrix}u & 1\end{matrix} ) + i & for usre request number ( x \vert 1 )\end{matrix} & ( 6 )\end{matrix}$$

The computation of kP in parallel with the proposed method can be performed efficiently using the following algorithm.

Algorithm 1: Efficient Postcomputations-Based Method.

| | |
|---|---|
| 1. | Inputs: P, k |
| 2. | By padding k with zeros if necessary and writingk = |
| | $( {k}^{( u - 1 )} ‖ {k}^{( u - 2 )} ‖ … ‖ {k}^{( 3 )} ) , where {k}^{( i )} is a key partition of length ⌈ \frac{m}{u} ⌉ bits .$ |
| 3. | Initialisation: Q ← P, R ← O. |
| 4. | Key partitions association with cryptoprocessors: |
| | 4.1. for i = 0 to u − 1 do |
| | 4.1.1.(k⁽ⁱ⁾, Cryptoprocessor₍ⱼ₎), where j is defined in equation (6) |
| 5. | Parallel Scalar Multiplication: |
| | 5.1. For i = 0 to u − 1 do in parallel |
| | 5.1.1. Q ← Binary method (k⁽ⁱ⁾, Pᵢ) |
| | 5.1.2. If (i > 0), then |
| | 5.1.2.1.for c = 0 to iv do |
| | 5.1.2.1.1. Q ← 2Q |
| | 5.1.3.R ← R + Q |
| 6. | Output R |

The pseudo code of the proposed method is given in Algorithm 1. The multiplier k is partitioned into u partitions with equal sizes. The partitioning step is performed at Step 2. For a particular k and P, each key partition is mapped to a certain cryptoprocessor according to equations (5) and (6) in Step 4. Parallel scalar multiplications start at Step 5. Each partition is processed independently in parallel by an individual cryptoprocessor. Only partition k⁽⁰⁾ does not require any postcomputations. The remaining partitions need postcomputations after executing the binary algorithm (Step 5.1.1). Finally, the resulting points of each partition are accumulated in the accumulation point R (Step 5.1.3) which requires u−1 extra point additions.

### EXAMPLE

Let k=(1000 0101 1100 0011)₂=(34243)₁₀, m=16, u=4. The key partitions are k⁽⁰⁾=0011, k⁽¹⁾=1100, k⁽²⁾=0101, and k⁽³⁾=1000.

(a) The scalar multiplication of these partitions is then computed in parallel for a single request, each by an individual processor, as

s_{0=[2}(2(2(0)P₁+(0)P₁)+(1)P₁)+(1)P₂]=3P₂,

s₁=(2⁴)[2(2(2(1)P₁|(1)P₁)|(0)P₁)|(0)P₁]=192P₁,

s₂=(2⁸)[2(2(2(0)P₁+(1)P₁)+(0)P₁)|(1)P₁]=1280P₁ and

s₃=(2¹²)[2(2(2(1)P₁+(0)P₁)+(0)P₁)+(0)P₁]=32768P₁,

Finally, kP₁ is computed as

kP₁=s₀+s₁=s₂+s₃=3P₁+192P₁+1280P₁+32768P₁=34243P₁.
(b) The scalar multiplication of these partitions is then computed in parallel for two consecutive requests, using the same key and two different points for simplicity, as

### Processor₍₀₎:

s_{0,P1}−[2(2(2(0)P₁+(0)P₁)+(1)P₁)+(1)P₁]−3P₁

s_{0,P2}=(2¹²)[2(2(2(1)P₂+(0)P₂)+(0)P₂)+(0)P₂]=32768P₂

### Processor₍₁₎:

s_{1,P1}=(2⁴)[2(2(2(1)P₁+(1)P₁)+(0)P₁)+(0)P₁]=192P₁

s_{1,P2}=(2⁸)[2(2(2(0)P₂+(1)P₂)+(0)P₂)+(1)P₂]=1280P₂

### Processor₍₂₎:

s_{2,P1}=(2⁸)[2(2(2(0)P₁+(1)P₁)+(0)P₁)+(1)P₁]=1280P₁

s_{2,P2}=(2⁴)[2(2(2(1)P₂+(1)P₂)+(0)P₂)+(0)P₂]=192P₂

### Processor₍₃₎:

s_{3,P1}=(2⁸)[2(2(2(0)P₁+(1)P₁)+(0)P₁)+(1)P₁]=1280P₁

s_{2,P2}=(2⁴)[2(2(2(1)P₂+(1)P₂)+(0)P₂)+(0)P₂]=192P₂

Finally, kP₁ and kP₂ are computed concurrently as

kP₁=s_{0,P1}s_{1,P1}+s_{2,P1}+s_{3,P1}3P₁+192P₁+1280P₁+32768P₁=34243P₁

kP₂=s_{3,P2}s_{2,P2}+s_{1,P2}+s_{0,P2}=32768P₂+1280P₂+192P₂+3P₂=34243P₂

### Performance Analysis

The time complexity of the proposed method, depending on the number of consecutive number of requests, denoted here by r, to compute kPs equal:

$$time complexity = \frac{r}{2} ( ( u + 1 ) ( v ) DBL + ( \frac{v}{2} + u - 1 ) ADD )$$

The space complexity of the proposed method, in terms of number of stored points, on the other hand, depends on the number of partitions z, that will be processed by the u processors using the binary method. Each processor requires the storage of two points to perform scalar multiplications of two consecutive requests using the binary method as shown in the example above. No precomputations are required and accordingly only the base points will be also stored and shared between the parallel processors. Finally, the accumulation point will be required for the accumulation process at the end. Accordingly, the space complexity of the proposed method is equal to 2u+4 points.

### REFERENCES

[1] N. Koblitz. “Elliptic Curve Cryptosystems”, Mathematics of Computation, vol. 48, pp. 203-209, 1987.
[2] R. Rivest, A. Shamir and L. Adleman, “A method for obtaining digital signatures and public key cryptosystems,” Communications of the ACM, vol. 21, no. 2, pp. 120-126, 1978.
[3] I. Blake, G. Seroussi and N. Smart, Elliptic Curves in Cryptography, Cambridge University Press, New York, 1999.
[4] D. Hankerson, A. J. Menezes, and S. Vanstone, Guide to Elliptic Curve Cryptography, Springer-Verlag, 2004.
[5] E. Brickell, D. Gordon, K. McCurley and D. Wilson, “Fast exponentiation with precomputations”, Advances in Cryptology—Eurocrypt′92 (LNCS 658, Springer-Verlag), pp. 200-207, 1993.
[6] T. F. Al-Somani and M. K. Ibrahim, “Generic-point parallel scalar multiplication without precomputations,” IEICE Electronics Express vol. 6, no. 24, pp. 1732-1736, December 2009.
[7] T. F. Al-Somani, “Performance Analysis of the Postcomputation-based Generic-Point Parallel Scalar Multiplication Method,” Global Journal of Computer Science and Technology, vol. 10, issue 11, pp. 32-37, October 2010.

The aforementioned article by T. F. Al-Somani and M. K. Ibrahim “Generic-point parallel scalar multiplication without precomputations,” IEICE Electronics Express vol. 6, no. 24, pp. 1732-1736, December 2009, is incorporated herein in its entirety by reference as further background for the invention.

While the invention has been described in connection with its preferred embodiments, it should be recognized that changes and modifications may be made therein without departing from the scope of the appended claims.

What is claimed is:

1. A method for efficient postcomputation-based generic-point parallel scalar multiplication, said method comprising the steps of:
providing a plurality of elliptic curve cryptoprocessors;
using the plurality of elliptic curve cryptoprocessors to perform scalar multiplication of a group of points on an elliptic curve in which kP denotes the scalar multiplication and wherein k is an integer and P is a point on the elliptic curve; and
computing scalar multiplication on the plurality of elliptic curve cryptoprocessors by a series of point doubling and point additions that depend on the bit sequence that represents the scalar multiplier k; and
wherein the multiplier k is partitioned into u partitions that are processed by the plurality of elliptic curve processors as k−(k^{(u-1)}∥k^{(u-2)}∥ . . . ∥k⁽⁰⁾); and
in which the scalar multiplication product is then computed as
$$kP = {\sum }_{0 \leq i \leq u} {s}_{i} ,$$

2. The method for efficient postcomputation-based generic-point parallel scalar multiplication according to claim 1, in which the input k is padded with zeros and k−(k^{(u-1)}∥k^{(u-2)}∥ . . . ∥k⁽⁰⁾), wherein k⁽ⁱ⁾ is a key partition of length
$$⌈ \frac{m}{u} ⌉$$
bits.

3. The method for efficient postcomputation-based generic-point parallel scalar multiplication according to claim 2, that includes the step of initialization: Q←P, R←O.

4. The method for efficient postcomputation-based generic-point parallel scalar multiplication according to claim 3, in which key partitions are associated with the elliptic curve cryptoprocessors for
i=0 to u−1 do; and
(k⁽ⁱ⁾, cryptoprocessor₍ⱼ₎ where j is defined as
$$j - \{ \begin{matrix}i & for request number ( x ) \\ ( u - 1 ) + i & for usre request number ( x + 1 )\end{matrix}$$

5. The method for efficient postcomputation-based generic-point parallel scalar multiplication according to claim 4, in which:
5. Parallel Scalar Multiplication:
5.1. For l=0 to u−1 do in parallel
5.1.1. Q←Binary method (k⁽ⁱ⁾, Pᵢ)
5.1.2. If (l>0), then
5.1.2.1. for c=0 to iv do
5.1.2.1.1. Q←2Q
5.1.3. R<R Q

6. The method for efficient postcomputation-based generic-point parallel scalar multiplication according to claim 5, in which the multiplier k is partitioned into u partitions of equal sizes.

7. The method for efficient postcomputation-based generic-point parallel scalar multiplication according to claim 6, wherein each partition is processed independently in parallel by an individual cryptoprocessor.

8. The method for efficient postcomputation-based generic-point parallel scalar multiplication according to claim 7, in which k⁽⁰⁾ does not include any postcomputation.

9. The method for efficient postcomputation-based generic-point parallel scalar multiplication according to claim 8, in which the resulting points of each partition are accumulated in an accumulation point R which requires u−1 extra point additions.

10. A method for efficient postcomputation-based generic-point parallel scalar multiplication, said method consisting of:
providing eight elliptic curve cryptoprocessors;
using the eight elliptic curve cryptoprocessors to perform scalar multiplication of a group of points on an elliptic curve in which kP denotes scalar multiplication and wherein k is an integer and P is a point on the elliptic curve;
computing scalar multiplication on the plurality of elliptic curve cryptoprocessors by a series of point doubling and point additions that depend on the bit sequence that represents the scalar multiplier k; and
wherein the multiplier k is partitioned into u partitions that are processed by the eight elliptic curve processors as k−(k^{(u-1)}∥k^{(u-2)}∥ . . . ∥k⁽⁰⁾; and
in which the scalar multiplication product is then computed as
$$kP = {\sum }_{0 \leq i \leq u} {s}_{i} ,$$

11. The method for efficient postcomputation-based generic-point parallel scalar multiplication according to claim 10, in which the input k is padded with zeros and k−(k^{(u-1)}∥k^{(u-2)}∥ . . . ∥k⁽⁰⁾, wherein k⁽ⁱ⁾ is a key partition of length ┌m/u┐ bits; and
and includes the step of initialization: Q←P, R←O;
in which key partitions are associated with the elliptic curve cryptoprocessors for
i=0 to u−1 do; and
k⁽ⁱ⁾, cryptoprocessor₍ⱼ₎ where j is defined as
$$j = \{ \begin{matrix}i & for request number ( x ) \\ ( u - 1 ) + i & for usre request number ( x + 1 )\end{matrix}$$
in which:
5. Parallel Scalar Multiplication:
5.1. For i=0 to u−1 do in parallel
5.1.1. Q←Binary method (k⁽ⁱ⁾, Pᵢ)
5.1.2. If (i>0), then
5.1.2.1. for c=1 to iv do
5.1.2.1.1. Q←2Q
5.1.3.R←R+Q;
in which the multiplier k is partitioned into u partitions of equal sizes;
wherein each partition is processed independently in parallel by an individual cryptoprocessor;
in which k⁽⁰⁾ does not include any postcomputation; and
in which the resulting points of each partition are accumulated in an accumulation point R which requires u−1 extra point additions.
